(19) United States
(12) Patent Application Publication
(10) Pub. No.: US 2004/0153644 A1
(43) Pub. Date: Aug. 5, 2004

(54) Preventing execution of potentially malicious software

(76) Inventors: Bruce McCorkendale, Los Angeles, CA (US); Carey S. Nachenberg, Northridge, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/359,422

(22) Filed: Feb. 5, 2003

(51) Int. Cl. G06F 11/30

(52) U.S. Cl. 713/156; 713/200

(57) ABSTRACT

Potentially malicious software is detected and prevented from installing and/or executing on client devices (122). A software developer sends software to a certifying authority (114) in order to obtain (710) a certification for the software. The certification uniquely identifies the software and allows any tampering to be detected. The software developer distributes (712) the software to the client devices (122). A client device (122) asks an execution authority (118) whether the software is malicious. The execution authority (118) maintains a database (514) specifying the status of certain software. If the status of the software at the client device (122) is in the database, the execution authority (118) reports it to the client device. The execution authority (118) can also analyze (716) the frequency of software execution requests from client devices (122) to determine whether the software is malicious.

### BACKGROUND OF THE INVENTION

1. Field of the Invention

This invention pertains in general to computer security and in particular to preventing a software worm or other malicious and/or unauthorized code from executing on a computer system.

2. Background Art

A “worm” is a computer program that attempts to infect multiple computer systems. There are a number of ways a worm can initially execute on a computer system. For example, a computer user might unintentionally download the worm from the Internet as a parasitic virus attached to a program. Alternatively, a worm might infect the computer system using transmission media such as email scripts, buffer overflow attacks, password cracking, etc.

Typically, the primary purpose of a worm is to spread to other computer systems. However, a worm can also include functionality to infect files on the computer system, destroy data on the computer system, and/or perform other malicious actions. A successful worm spreads rapidly and can quickly damage many computer systems.

One technique for preventing worm attacks and virus infections is to install anti-virus software on the computer system in order to detect the presence of worms, viruses, and other malicious software. However, it is sometimes not practical to execute anti-virus software on certain hardware platforms. Moreover, anti-virus software utilizes various tools, such as string scanning and emulation, that might fail to detect previously-unknown malicious software. In addition, certain types of worms use programming techniques, such as polymorphic or metamorphic code, that hamper the effectiveness of anti-virus software.

Accordingly, there is a need in the art for a way to detect software worms and other malicious code and prevent it from spreading. A solution meeting this need should detect unknown, as well as known, worms.

### DISCLOSURE OF INVENTION

The above needs are met by a utilizing an execution authority (118) that informs computer systems and other client devices (122) whether it is safe to execute certain software. A software developer develops the software and submits it to a certifying authority (114). The certifying authority (114) certifies the software, which identifies the software and allows detection of any tampering with the software. In one embodiment, the certifying authority (114) calculates a hash of the software and uses it to sign the software.

The software developer distributes the software to client devices (122) using conventional channels. At some point, one or more of the client devices (122) attempts (714) to execute (as used herein, “execute” also includes “install”) the software. As part of this process, the client device (122) determines (716) whether the software is potentially malicious. The client device (122) evaluates the software's signature to determine whether the software has been altered. If the software has not been altered, the client device (122) determines whether status information for the software, such as whether the software should be allowed or denied execution, is contained in an authority cache module (618). If the status information is not in the cache (618), the client device (122) contacts an execution authority (118).

The execution authority (118) maintains a database (514) holding status information (518) for software. In one embodiment, each piece of software identified by a signature has a status of “allow,” “deny,” or “unknown.” The execution authority (118) provides this information to the requesting client devices (122), which can then determine whether to allow or deny execution. In one embodiment, the status information is provided in part by the certifying authority (114). For example, the certifying authority (114) can provide the signatures of certified software to the execution authority (118) and the execution authority (118) can set the initial status of the signatures to “allow” because the software is presumably non-malicious.

In one embodiment, the execution authority (118) includes a malicious software detection module (512) that can detect malicious software. In one embodiment, this module (512) analyzes the frequency of client device requests to execute certain software. An abnormally high frequency of client device requests to execute the same software may indicate that the software is a worm or other malicious software.

If the software status is “unknown,” one embodiment of the execution authority (118) causes a copy of the software to be sent to an analysis authority (120). The analysis authority (120) determines whether the software is malicious and reports this information to the execution authority (118). Accordingly, the present invention stops worms and other malicious software from executing on the client devices (122) by providing a framework that prevents the client devices from executing certain software and providing a way to detect potentially-malicious software.

### BRIEF DESCRIPTION OF THE DRAWINGS

FIG. 1 is a high-level block diagram of a computing environment 100 according to one embodiment of the present invention;

FIG. 2 is a high-level block diagram illustrating a functional view of a typical computer system 200 for use by one of the entities illustrated in the environment 100 of FIG. 1 according to an embodiment of the present invention;

FIG. 3 is a high-level block diagram illustrating functional modules in the software developer system 110 according to one embodiment of the present invention;

FIG. 4 is a high-level block diagram illustrating functional modules in the certifying authority 114 according to an embodiment of the present invention;

FIG. 5 is a high-level block diagram illustrating functional modules in the execution authority 118 according to an embodiment of the present invention;

FIG. 6 is a high-level block diagram illustrating functional modules in one embodiment of a client device 122; and

FIG. 7 is a flow chart illustrating steps for blocking malicious software from executing according to one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

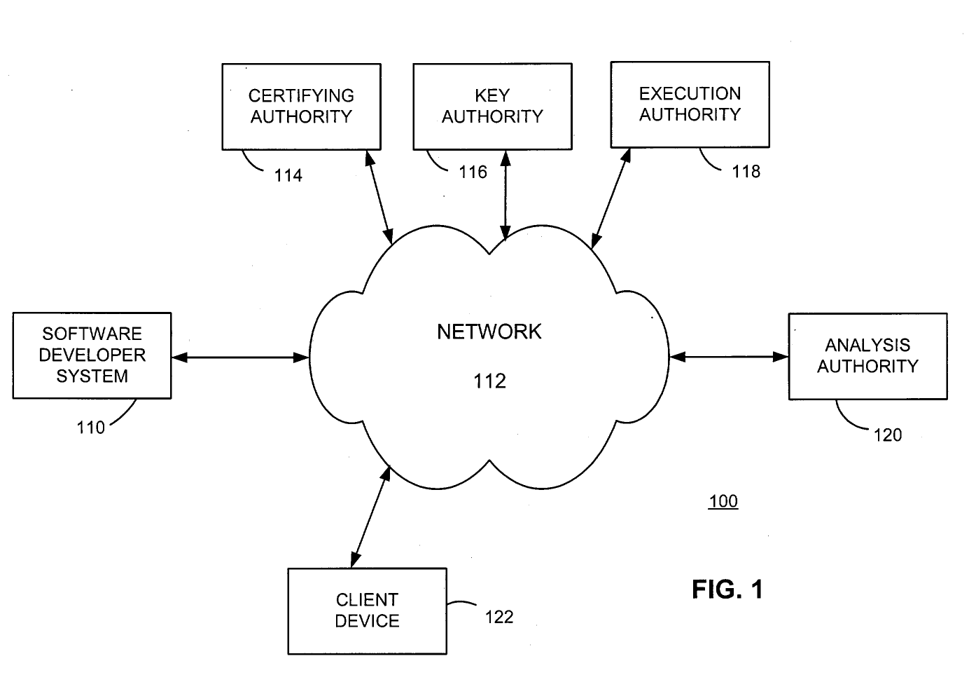

FIG. 1 is a high-level block diagram of a computing environment 100 according to one embodiment of the present invention. FIG. 1 illustrates a software developer system 110 connected to a network 112. The network 112 also connects a certifying authority 114, a key authority 116, an execution authority 118, an analysis authority 120, and a client device 122.

The network 112 provides communications between and among the other entities illustrated in the computing environment 100 of FIG. 1. In one embodiment, the network 112 is the Internet and uses wired and/or wireless links. All or part of the network 112 may include a cellular telephone network or other data network having a peering point with the Internet: The network 112 can also utilize dedicated or private communications links that are not necessarily part of the Internet. The entities illustrated in FIG. 1 use conventional communications technologies such as the transmission control protocol/Internet protocol (TCP/IP) to communicate over the network. The entities of FIG. 1 also use conventional communications protocols such as the hypertext transport protocol (HTTP), the simple mail transfer protocol (SMTP), the file transfer protocol (FTP), etc. The entities can also engage in secure communications using technologies including the secure sockets layer (SSL), Secure HTTP and/or virtual private networks (VPNs). The communicated messages utilize conventional data encodings such as hypertext markup language (HTML), extensible markup language (XML), etc. In one embodiment, all or part of the network 112 includes non-electronic links. For example, the software developer system 110 may communicate with the certifying authority 114 via U.S. mail, voice telephone, etc.

The software developer system 110 is used by a software developer to develop software for execution on the client device 122. This software may include utilities, application programs, operating system components, etc. The software developer distributes the software to the client device 122 using conventional techniques, such as by selling boxed software, making software available for download over the network 112, etc. Although only one software developer system 110 is illustrated in FIG. 1, it will be understood that embodiments of the present invention can have hundreds or thousands of such systems.

The client device 122 is typically utilized by an end-user to execute software developed on the software developer system 110. The client device 122 includes functionality enabling the client device 122 to communicate with the execution authority 118 regarding software on the client device. This functionality can prevent the execution of software that the execution authority 118 identifies as possibly malicious.

In one embodiment, the client device 122 is a conventional computer system executing, for example, a Microsoft Windows-compatible operating system (OS), Apple OS X, and/or a Linux-compatible OS. In another embodiment, the client device 122 is another device having computer functionality, such as a personal digital assistant (PDA), cellular telephone, video game system, etc. Although only one client device 122 is shown in FIG. 1, embodiments of the present invention can have thousands or millions of such devices. Moreover, a client device 122 can be a software developer system 110 and vice versa depending upon the context.

In one embodiment, the client device 122 and/or the software developer system 110 includes a trusted computing platform. This platform implements technologies and protocols that allow third parties to “trust” the platform for certain purposes. The platform can “prove” to third parties that the platform is trustworthy and has not been altered in a way that would betray the trust. In one embodiment, the trusted computing platform is similar to a conventional computer system, except that the trusted platform has a secure storage that can store data in a location that is tamper-proof and inaccessible to non-trusted software and has a secure execution environment that executes tamper-proof software. Examples of trusted computing platforms that can be utilized with the present invention include the platform advocated by the Trusted Computing Platform Alliance (TCPA) of Hillsboro, Oregon, and the “Palladium” platform advocated by Microsoft Corp. of Redmond, Wash., for the Windows family of operating systems.

The key authority 116 includes a computer system and is utilized to provide private/public key pairs and certificates to the other entities in the environment 100 of FIG. 1. As is known in the art, a key is a mathematical value, such as a long integer, that is usually generated according to a random or pseudo-random technique. In public-key encryption, the private/public key pair is related such that a message encrypted with the private key can be decrypted with the public key and vice versa, but the public key and message cannot be used (at least in a reasonable amount of time) to calculate the private key. The key authority can use conventional techniques to generate the key pairs, including, for example, techniques utilizing the Diffie-Hellman, Knapsack, DSA, and/or RSA key-generation schemes. The key authority 116 has a well-known public key. A certificate is a message encrypted by the key authority's private key that can be decrypted using the key authority's public key. In one embodiment, the functionality of the key authority 116 is performed by one of the other authorities illustrated in FIG. 1, such as the certifying authority 114 or the execution authority 118.

In one embodiment, the key authority 116 issues a private key and digital certificate to the certifying authority 114. The certificate is encrypted using the key authority's private key and typically includes an identification of the certifying authority 114 and the public key corresponding to the certifying authority's private key.

The certifying authority 114 includes a computer system and is utilized to certify software developed on the software developer system. In general, the certifying authority 114 uses the certificate issued by the key authority 114 to digitally sign the software. The signature serves two purposes: 1) it identifies the signed software; and 2) it allows third parties to detect any alteration of the signed software.

Other embodiments of the present invention use less rigorous code-signing schemes than the one described herein. The certifying authority 114 can use a code signing scheme that does not require a certificate from a key authority 116 or other entity. Such embodiments may be deemed more desirable due to the reduced overhead on the software developer system 110 and certifying authority 114.

The execution authority 118 includes a computer system and contains functionality and information utilized by client devices 122 to prevent the execution of malicious software such as worms. In one embodiment, the execution authority 118 is adapted to communicate with the client devices 122 to identify software being executed on the devices. The execution authority 118 monitors the software executions and utilizes execution frequency statistics to identify possible software worms. In one embodiment, the execution authority 118 includes a list of software developed by the software developer system 110 and certified by the certifying authority 114. For each item of software in the list, the execution authority 118 maintains status information indicating whether the software is malicious or benign. If the execution frequency statistics and/or the list indicates that software on a client device 112 is possibly malicious, the execution authority 118 instructs the client device 122 that this is the case.

The analysis authority 120 includes a computer system and contains functionality and information for performing analysis of certain software identified by the execution authority 118. For example, in one embodiment, the execution authority 118 notifies the analysis authority 120 when the execution authority detects a possible software worm. In response, the analysis authority 120 receives a copy of the software and analyzes it to determine whether the software is malicious. In one embodiment the analysis is performed by Digital Immune System software available from Symantec Corp. of Cupertino, Calif. The analysis authority 120 reports the results of the analysis to the execution authority 118, and the latter authority relays this information to the client devices 122.

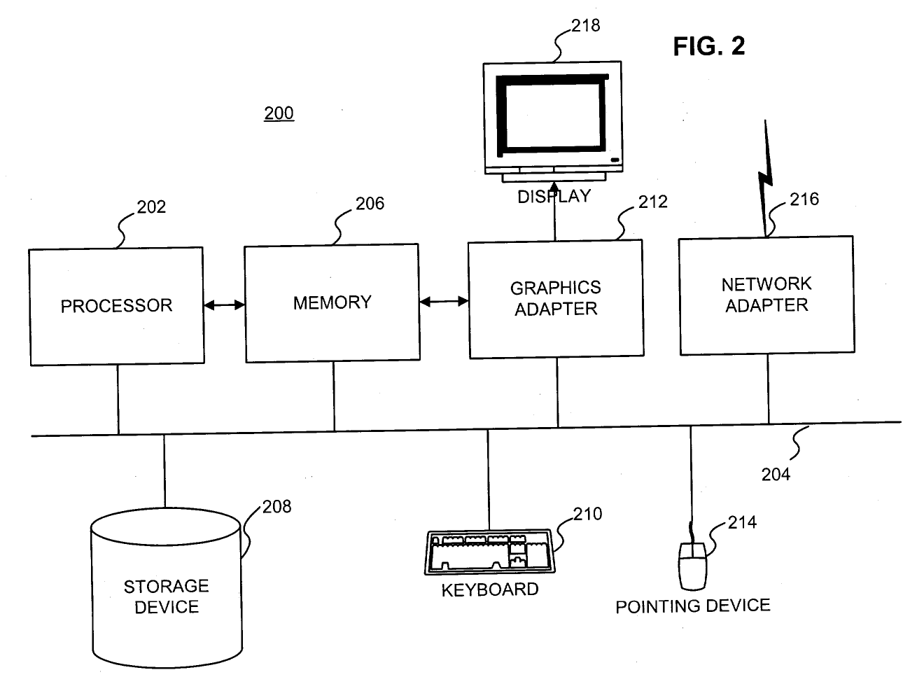

FIG. 2 is a high-level block diagram illustrating a functional view of a typical computer system 200 for use as one of the entities illustrated in the environment 100 of FIG. 1 according to an embodiment of the present invention. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86, SUN MICROSYSTEMS SPARC, or POWERPC compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 112.

As is known in the art, the computer system 200 is adapted to execute computer program modules for providing functionality described herein. As used herein, the term “module” refers to computer program logic for providing the specified functionality. A module can be implemented in hardware, firmware, and/or software. In one embodiment, the modules are stored on the storage device 208, loaded into the memory 206, and executed by the processor 202. As described above, a computer system implementing a trusted computer architecture differs slightly from the one illustrated in FIG. 2.

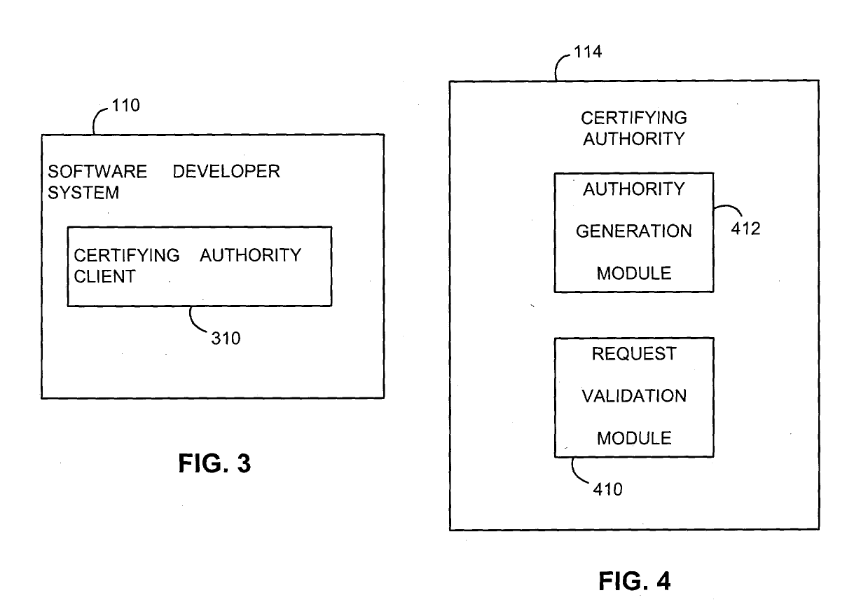

FIG. 3 is a high-level block diagram illustrating functional modules in the software developer system 110 according to one embodiment of the present invention. Those of skill in the art will recognize that the functionality attributed to the modules in the description of FIG. 3 and the other figures can be performed by other or different modules in other embodiments. The software developer system 110 includes a certifying authority client module 310 for supporting communications with the certifying authority 114. This module 310 allows the software developer to securely transmit an application program or other piece of software to the certifying authority 114 as part of a request to certify the software. Moreover, the module 310 allows the software developer to receive a certified copy of the software back from the certifying authority 114. The certifying authority client 310 also allows the developer to respond to requests for information or other input from the certifying authority 114. In one embodiment, the certifying authority client 310 does not explicitly identify the software developer system 110 to the certifying authority 114. In another embodiment, the certifying authority client 310 provides information to the certifying authority 114 allowing the authority to identify the software developer.

FIG. 4 is a high-level block diagram illustrating functional modules in the certifying authority 114 according to an embodiment of the present invention. The certifying authority 114 includes a request validation module 410 for validating a certification request received from a software developer system 110 or other entity on the network 112. The request validation module 410 validates the requests in order to screen out requests from unknown entities and/or automated processes. For example, malicious software, such as a polymorphic virus, could be configured to send variants of itself to the certifying authority 114 in order to obtain certification of the variant. The request validation module 410 detects and deletes these sorts of malicious certification requests.

In one embodiment, the request validation module 410 utilizes a challenge-response mechanism to screen requests. In response to receiving a request, the module 410 sends a challenge to the requestor. If the requestor does not respond with the correct response, the request is deleted. In one embodiment, the challenge is presented in a form that is computationally expensive to programmatically decipher and answer. For example, the challenge can be a graphic containing a human-readable question such as “what is five plus five?” obscured by some random data. A human can quickly read the question and submit the appropriate response, but a software program will have great difficulty in parsing the question and generating the answer. In another embodiment, the question is audible rather than legible. In one embodiment, the challenges (e.g., questions) are held in a database (not shown) and the request validation module 410 randomly selects a challenge in response to a certification request.

In another embodiment, the request validation module 410 requires the requestor to provide additional information in order to pass through the validation procedure. The module 410 can require the requestor to provide identifying information, such as an email address, name, company, etc. and then use this information to determine whether to validate the request. For example, the module 410 can email an access code to the provided address and then require that the requestor use the access code when making the request.

An authority generation module 412 in the certifying authority 114 certifies software in response to validated requests. In one embodiment, the authority generation module 412 uses code signing techniques to certify the software. The module 412 uses a hash function to compute a hash of the software. As is known in the art, a “hash function” is a function, mathematical or otherwise, that takes an input string and converts it to a fixed-size output string. In one embodiment, the authority generation module 412 uses the software as the input to the hash function and obtains a much smaller output string (the “hash”). The hash function is selected so that any change to the software will produce a change in the hash. Therefore, the hash acts as a sort of fingerprint of the software. Examples of hash functions that can be used by embodiments of the present invention include MD5 and SHA.

The authority generation module 412 utilizes its private key (obtained from the key authority 116) to encrypt the hash. In another embodiment, the private key is utilized by the hash function itself to produce the hash, thereby eliminating the need to perform a discrete encryption of the hash. The module 412 signs the software by storing the encrypted hash and the certificate issued by the key authority 116 with the software. The signature identifies the software and allows any alteration of the software to be detected. The certifying authority 114 sends the signed software to the software developer system 110.

In one embodiment, certifying authority 114 includes trust level information with the signed software. This information indicates a confidence level that the software is not malicious. In one embodiment, requesters that provide identifying information, such as the name and address of the software developer, are granted a higher trust level than requesters that remain anonymous. This trust level information can be utilized by the client devices 122 when the devices determine whether to execute the software.

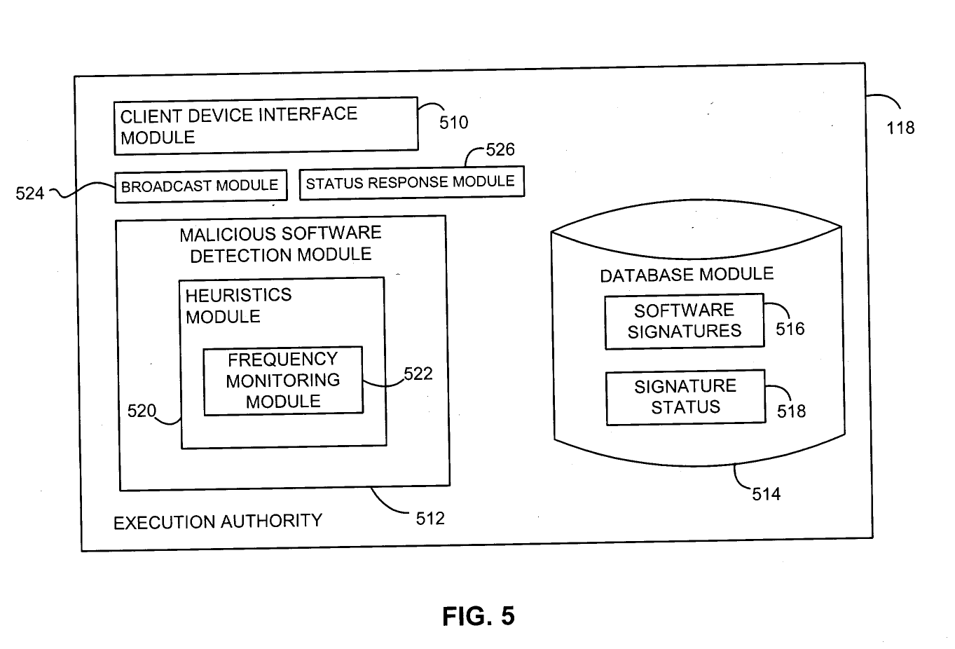

FIG. 5 is a high-level block diagram illustrating functional modules in the execution authority 118 according to an embodiment of the present invention. A client device interface module 510 facilitates communications between the execution authority 118 and the client devices 122. In general, the interface module 510 receives messages from client devices 122 identifying software (via the software's signature) that the devices have been instructed to execute. The interface module 510 also sends messages to the client devices 122 indicating whether the identified software or other software on the client devices is possibly malicious.

The execution authority 118 also includes a malicious software detection module 512 and a database module 514. A software signatures module 516 in the database module 514 stores the signatures of software “known” to the execution authority 118. In one embodiment, these signatures are compiled from the signatures received from the client devices 122. In another embodiment, all or some of the signatures are supplied to the execution authority by the software developers, certifying authority 114, and/or another source. A signature status module 518 in the database 514 holds data describing the status of each piece of software identified by a signature. In one embodiment, the possible statuses are “allow,” “deny,” and “unknown.” The “allow” status indicates that the associated software is not known to be malicious. The “deny” status indicates that the associated software is possibly malicious. The “unknown” status indicates that the execution authority 118 has no information regarding the maliciousness of the software. In one embodiment, the initial statuses for the software are determined from information received from the certifying authority 114.

Other embodiments can have different statuses depending upon the operation of the execution authority 118. For example, in one embodiment the database utilizes a range of values (e.g., 1-10) to describe the likelihood that software is malicious. The appropriate value/status for the software can be determined from trust level information included with the signed software or received from the certifying authority 114.

The malicious software detection module 512 determines whether software is malicious based, in part, on the information held in the database module 514. In normal operation, the malicious software detection module 512 looks up the statuses of signatures received from the client devices 122 in the database module 514 and reports the statuses back to the client devices 122. Accordingly, if a client device 122 requests to execute software marked as “deny” in the database module 514, the detection module 512 will report this status back to the client device 122, thereby preventing the software from being executed.

If the database module 514 does not contain a signature received from the client device 122 (i.e., the software is unknown), the malicious software detection module 512 creates an entry in the database for the signature and marks it with a default status. In one embodiment, the default status is “allow” because the software is certified by the certifying authority and presumably safe. In another embodiment, the default value is “unknown.” The execution authority 118 reports the default value to the client device 122. Depending upon its configuration, the client device 122 can refuse to execute software having an “unknown” status.

When the malicious software detection module 512 receives a signature that is not in the database module 514, one embodiment uses the client device interface module 510 to request that the client device 122 to send a copy of the software to the execution authority 118. Upon receipt of the software, the execution authority 118 sends a copy of the software to the analysis authority 120 for subsequent analysis. The execution authority 118 updates the signature status 518 in the database module 514 in response to the results of the analysis. In another embodiment, the malicious software detection module 512 requests that the client device 122 send a copy of the software directly to the analysis authority 120.

In one embodiment, the malicious software detection module 512 also uses heuristics held in a heuristics module 520 to recognize potentially malicious software. In general, detection module 512 uses the heuristics module 520 to analyze the software signatures received from the client devices 122 to identify characteristics of the software that are indicative of malicious software. If the heuristics indicate that software is malicious, the malicious software detection module 512 updates the software's status in the database module to “deny.”

In one embodiment, the heuristics module 520 includes a frequency monitoring module 522 that detects potentially malicious software based on the frequency of software execution requests received from the client devices 122. This module 522 is adapted to declare that software is potentially malicious upon the occurrence of an abnormally high frequency of requests from different client devices 122 to execute the same software within a relatively short time period. This high frequency of requests is indicative of a software worm trying to spread among the client devices 122 and thus suggests that the software is malicious. Similarly, an abnormally high frequency of requests from a single client device 122 to execute the same software may also indicate that the software is malicious.

In one embodiment, the frequency monitoring module 522 tracks software execution frequencies over sliding time windows. For example, the module 522 can track the number of execution requests for a particular piece of software in any given hour. If the number of executions exceeds a predetermined threshold, the module 522 determines that the software is malicious. In one embodiment, the module 522 holds separate thresholds for different software, thereby allowing the thresholds to be specified with a high degree of granularity. For example, the thresholds can be set based on trust level information included with the software.

One embodiment of the execution authority 118 also includes a broadcast module 524. This module 524 sends “malicious software” alerts to the client devices 122 via the client device interface module 510. These broadcasts allow the client devices 122 to identify malicious software in advance of the client devices being asked to execute the software. In addition, these broadcasts allow the client devices 122 to recognize malicious software that the execution authority 118 previously reported as “allow” or “unknown.”

In one embodiment, the broadcast module 524 sends broadcasts to the client devices 122 upon the detection of malicious software by the malicious software detection module 512. The broadcast module 524 can also send the broadcasts to only selected groups of client devices 122, such as only devices that have previously requested the status of certain software, upon detection of malicious software. In one embodiment, the broadcast module 524 spools the broadcasts and distributes them to client devices 122 at regular intervals and/or rates in order to avoid saturating the network 112.

The execution authority 118 can also include a status response module 526. This module 526 responds to status update messages from the client devices 122. In one embodiment, the client devices 122 periodically resubmit the signatures of software on the client devices 122 to the execution authority 118 in order to receive any updated status information. The status response module 526 utilizes the client device interface module 510 to receive these update requests, reads the signature statuses from the database module 514, and sends the updated statuses to the requesting client devices 122.

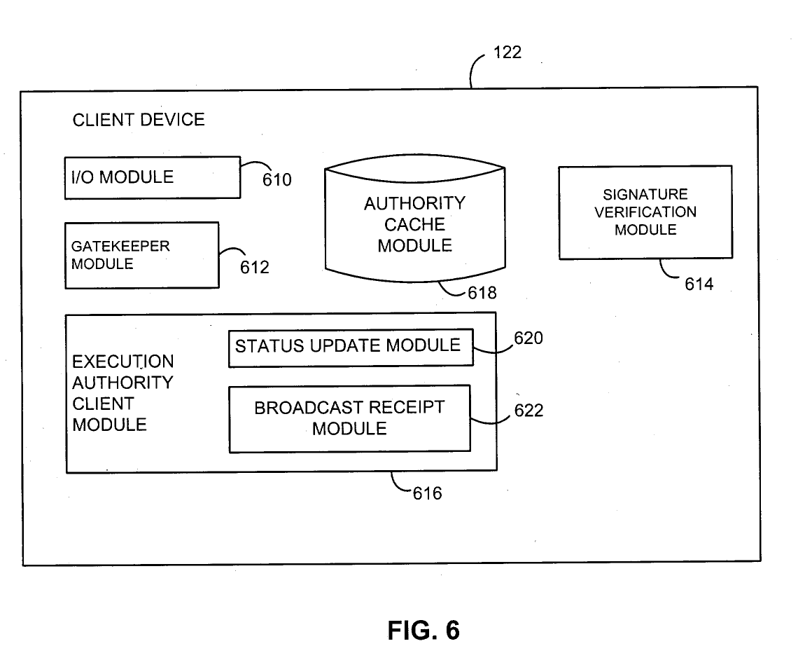

FIG. 6 is a high-level block diagram illustrating functional modules in one embodiment of a client device 122. In one embodiment, the functionality of some or all of the modules described herein is incorporated into an operating system executing on the client device 122. In another embodiment, the functions of some or all of the modules are performed by software executed by the client device 122 separately from the operating system. The client device 122 includes an input/output (I/O) module 610 for communicating with the other entities on the network 112.

A gatekeeper module 612 in the client device 122 controls the installation and/or execution of software by the client device. In one embodiment, the gatekeeper module 612 must be invoked by the client device 122 whenever certain software is installed and/or executed on the client device 122. Thus, the gatekeeper module 612 acts as a “gatekeeper” for the client device because software cannot be installed and/or executed without permission from it.

In one embodiment, gatekeeper module 612 is embodied in a dedicated routine that must be executed by the client device 122 in order to make new software available for execution. For example, the client device 122 can be configured to only execute software that is installed by a given installation routine. In this embodiment, the gatekeeper module 612 allows the installation routine to install only approved software. In another embodiment, the gatekeeper module 612 is embodied in a dedicated routine that must be executed by the client device 122 in order to execute installed software. For example, the client device 122 may be configured so that a specific loader routine must be used to load software into an executable area of memory. In this embodiment, the gatekeeper module 612 allows the loader routine to load only approved software.

Embodiments of the gatekeeper module 612 can utilize one or both of these techniques in order to stop the installation and/or execution of certain software. For purposes of simplicity and clarity, this description uses the term “execute” to mean “execute and/or install.” Therefore, the present invention includes client devices 122 that perform the gatekeeping function during (or prior to) installation of software and client devices that perform the gatekeeping function during (or prior to) execution of software. In a similar manner, the frequency monitoring module 522 in the execution authority 118 can utilize installation and/or execution frequency statistics to detect malicious software.

The gatekeeper module 612 utilizes a signature verification module 614 and status information provided by the execution authority 118 via an execution authority client module 616 to determine whether to permit or deny the execution of software. The signature verification module 614 determines whether the software attempting to execute includes a valid signature. In one embodiment, the verification module 614 performs this test by using the key authority's public key to decrypt the certificate to obtain the certifying authority's public key. The verification module 614 uses the certifying authority's public key to decrypt the hash of the software. The verification module 614 independently generates a hash of the software using the same technique utilized by the certifying authority 116 and compares the generated hash with the encrypted hash. If the hashes match, the signature is valid.

If the signature is invalid, the software is not signed, or another error arises during the signature verification process, one embodiment of the gatekeeper module 612 does not allow the software to be executed. If the signature is valid, the gatekeeper module 612 utilizes the execution authority client module 616 to determine the software's status. In one embodiment, the gatekeeper module 612 analyzes trust level information in the software to determine whether to utilize the execution authority client module 616. Software can have trust level information indicating that it is safe for the gatekeeper module 612 to execute the software without performing other security checks.

The execution authority client module 616 uses the I/O module 610 to contact the execution authority 118 and obtain the status information. The client module reports this information to the gatekeeper module 612, which then determines whether to allow the software to execute. The execution authority client module 616 can also send the software to the execution authority 118 and/or analysis authority 120 if requested to do so.

The client device 122 includes an authority cache module 618 for caching software signatures and corresponding status information received from the execution authority 118. In one embodiment, the authority cache module 618 stores a list of all software that the client device 122 has executed and attempted to execute and the corresponding status information. In another embodiment, the authority cache module 618 occasionally purges old information, thereby causing the client device 122 to check the status of rarely-utilized software. Other embodiments of the authority cache module 618 can use different caching schemes to determine when and how to cache information. The execution authority client module 616 checks the authority cache module 618 for status information before sending a request to the execution authority 118.

As illustrated in FIG. 6, the execution authority client module 616 also includes a status update module 620 and a broadcast receipt module 622. The status update module 620 periodically checks with the execution authority 118 and updates the status of software identified in the authority cache module 618. If the response to a status update message indicates that the status of software that previously attempted to execute or did execute has changed, one embodiment of the execution authority client module 616 notifies the gatekeeper module 612 of the change. The gatekeeper module 612 can then allow or stop the software from executing. In one embodiment, the frequency of the update requests sent to the execution authority 118 can vary. For example, it may desirable to check for updates to the status of “unknown” software more frequently than for other types of software.

The broadcast receipt module 622 receives broadcast messages received from the execution authority 118 and updates the corresponding status entry in the authority cache module 618. If the broadcast message indicates that the status software that previously attempted to execute or did execute, one embodiment of the execution authority client module 616 notifies the gatekeeper module 612 of the change. The gatekeeper module 612 can then allow or stop the software from executing. In addition, the broadcast receipt module 622 creates a new entry for the software in the authority cache module 618 if an entry did not previously exist, thereby allowing the client device 122 to recognize malicious software without having to contact the execution authority 118.

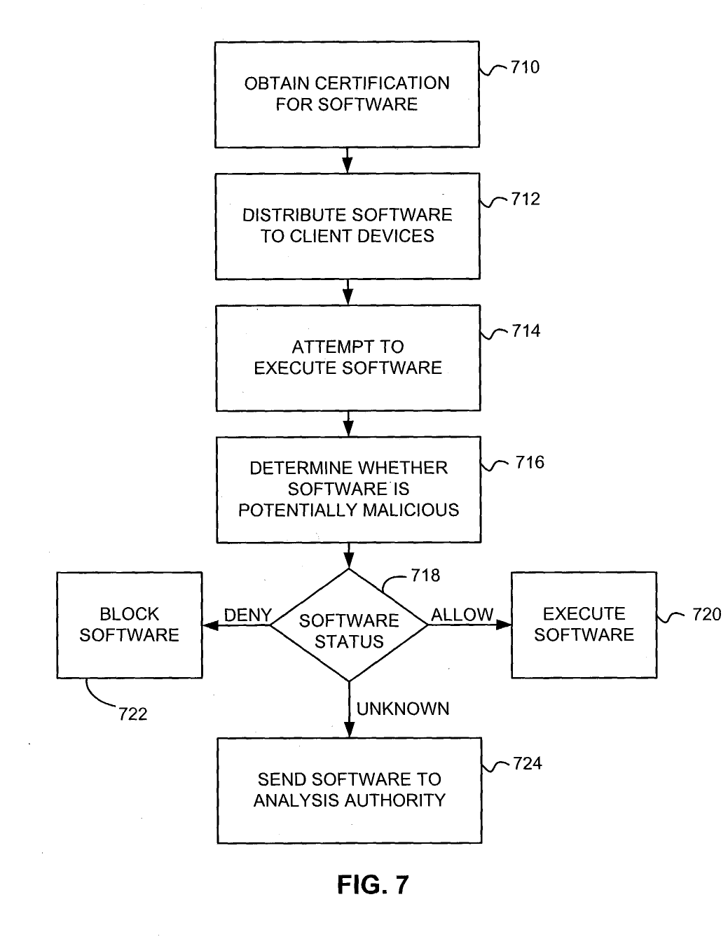

FIG. 7 is a flow chart illustrating steps for blocking malicious software from executing according to one embodiment of the present invention. It should be understood that these steps are illustrative only, and that other embodiments of the present invention may perform different and/or additional steps than those described herein in order to perform different and/or additional tasks. Furthermore, the steps can be performed in different orders than the one described herein.

The software developer sends software to the certifying authority 114 in order to obtain 710 a certification for the software. The certification includes a hash, digital signature, certificate, trust level information, and/or other information used to identify the software and detect tampering. The certified software is distributed 712 to the client devices 122 through standard distribution channels. The software developer and/or certifying authority 114 can also provide the software's signature to the execution authority 118.

At some point, one or more of the client devices 122 attempts 714 to execute the software. As part of this process, the client device 122 determines 716 whether the software is potentially malicious by verifying the software's signature, checking for the software's status in the authority cache module 618, and/or contacting the execution authority 118.

The execution authority 118 determines 716 whether the software is potentially malicious by checking for the software's signature in its database module 514 to see if the software's status has previously been determined by, for example, the certifying authority and/or the analysis authority 120. In addition, the execution authority 118 utilizes heuristics to determine 716 whether the software is potentially malicious. An abnormally high number of execution requests within a certain window of time may indicate that the software is a worm or otherwise malicious.

Once the client device 122 determines the status of the software, it determines 718 the appropriate action to take in response to the attempt to execute the software. If the software is not potentially malicious, i.e., its status is “allow execution,” the client device 122 executes the software. If the software is potentially malicious, i.e., its status is “deny execution,” the client device 122 blocks execution 722 of the software. If the client device 122 cannot determine whether the software is potentially malicious, i.e., its status is “unknown,” the client device 122 typically blocks execution of the software and optionally sends 724 a copy of the software to the analysis authority 120 for evaluation. Accordingly, the present invention stops worms and other malicious software from executing on the client devices 122 by providing a framework that prevents the client devices from executing certain software and providing a way to detect potentially-malicious software.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

We claim:

1. A system for preventing client devices from executing potentially malicious software, comprising:
a certifying authority for creating a certification for software, the certification including an identification of the software; and
an execution authority remote from the client devices and in communication with a database containing status information indicating whether the software is potentially malicious, the execution authority adapted to receive from a client device the identification of the software and provide the status information for the software to the client device.

2. The system of claim 1, wherein the certifying authority comprises:
an authority generation module adapted to use code signing to create the certification for the software.

3. The system of claim 1, wherein the certifying authority comprises:
a request validation module adapted to validate a request to certify software and reject invalid requests.

4. The system of claim 3, wherein the request validation module provides a requestor with a challenge and requestors that fail the challenge are invalid.

5. The system of claim 1, wherein the execution authority comprises:
a malicious software detection module for determining whether the software identified by the client device is potentially malicious.

6. The system of claim 5, wherein the malicious software detection module comprises:
a heuristics module for analyzing identifications of software received from client devices to identify characteristics that are indicative of malicious software.

7. The system of claim 5, wherein the malicious software detection module comprises:
a frequency monitoring module for detecting potentially malicious software responsive to a frequency of identifications of software received from the client devices.

8. The system of claim 7, wherein an abnormally high frequency of identifications received for a same software indicates that the software is malicious.

9. The system of claim 1, further comprising:
an analysis authority for analyzing software to determine whether the software is malicious, wherein results of the analysis are stored as status information in the database.

10. The system of claim 1, wherein the execution authority comprises:
a broadcast module for sending unsolicited messages including status information for software to the client devices.

11. A computer program product comprising:
a computer-readable medium having computer program code modules embodied therein for providing client devices with software status information, the computer program code modules comprising:
a database module for holding information describing signatures identifying software and for holding status information indicating whether software identified by the signatures is potentially malicious;
an interface module for receiving messages from client devices including signatures identifying software and for sending messages to the client devices describing the statuses of the identified software responsive to the status information in the database; and
a malicious software detection module for monitoring the messages from the client devices to determine whether the software identified therein is potentially malicious and for updating the status information in the database responsive thereto.

12. The computer program product of claim 11, wherein the malicious software detection module comprises:
a heuristics module for utilizing heuristics to analyze the signatures received from client devices to identify characteristics that are indicative of malicious software.

13. The computer program product of claim 11, wherein the malicious software detection module comprises:
a frequency monitoring module for determining whether identified software is potentially malicious responsive to a frequency of signatures received from the client devices.

14. The computer program product of claim 13, wherein receiving an abnormally high frequency of signatures identifying a same software indicates that the software is potentially malicious.

15. The computer program product of claim 11, further comprising:
a broadcast module for sending unsolicited messages describing the statuses of software to the client devices.

16. A computer program product comprising:
a computer-readable medium having computer program code modules embodied therein for preventing execution of potentially malicious software, the computer program code modules comprising:
an execution authority client module adapted to provide signatures identifying software to a remote execution authority and receive status information for the software indicating whether the software identified by the signatures is potentially malicious in response; and
a gatekeeper module adapted to selectively prevent the execution of software responsive to the status information received from the execution authority.

17. The computer program product of claim 16, further comprising:
an authority cache module adapted to cache the status information received from the execution authority, wherein the gatekeeper module is adapted to selectively prevent the execution of software responsive to the status information cached in the authority cache module.

18. The computer program product of claim 16, further comprising:
a signature verification module adapted to determine whether a signature for software is valid, wherein the gatekeeper module prevents the execution of software having an invalid signature.

19. The computer program product of claim 16, further comprising:
a status update module adapted to periodically request status updates for software from the execution authority.

20. The computer program product of claim 16, further comprising:
a broadcast receipt module adapted to receive from the execution authority unsolicited messages containing software signatures and status information.

21. A method for preventing client devices from executing potentially malicious software, comprising:
providing a signature identifying software to a remote execution authority;
receiving status information for the software from the execution authority, the status information indicating whether the software is potentially malicious; and
determining whether to execute the software responsive to the status information.

22. The method of claim 21, further comprising the step of:
caching the status information received from the execution authority in a local cache.

23. The method of claim 21, further comprising:
checking whether the signature for the software is valid, wherein the determining step does not execute software having an invalid signature.

24. The method of claim 21, further comprising:
periodically requesting status updates for software from the execution authority.

25. The method of claim 21, further comprising:
receiving from the execution authority an unsolicited message containing software signatures and corresponding status information.

26. A method for preventing client devices from executing potentially malicious software, comprising:
receiving messages from client devices including signatures identifying software;
monitoring the messages from the client devices to determine whether the identified software is potentially malicious;
updating status information for the software in a database responsive to the determination; and
sending the status information in the database for the identified software to the client devices.

27. The method of claim 26, wherein determining whether the identified software is potentially malicious comprises:
analyzing the signatures received from client devices to identify characteristics that are indicative of malicious software.

28. The method of claim 26, wherein determining whether the identified software is potentially malicious comprises:
determining whether identified software is potentially malicious responsive to a frequency of signatures received from the client devices.

29. The method of claim 28, wherein receiving an abnormally high frequency of signatures identifying a same software in a time period indicates that the software is potentially malicious.
